(19) United States
(12) Patent Application Publication
(10) Pub. No.: US 2026/0149034 A1
(43) Pub. Date: May 28, 2026

(54) SECONDARY BATTERY

(71) Applicant: Nissan Motor Co., Ltd., Kanagawa (JP)

(72) Inventors: Harumi Takada, Kanagawa (JP); Kazuyuki Sakamoto, Kanagawa (JP)

(73) Assignee: Nissan Motor Co., Ltd., Kanagawa (JP)

(21) Appl. No.: 19/100,435

(22) PCT Filed: Aug. 1, 2022
(86) PCT No.: PCT/IB2022/000434

§ 371 Date: Jan. 9, 2026

(51) Int. Cl. H01M 10/056; H01M 4/525; H01M 10/052; H01M 10/42; H01M 50/426; H01M 50/431; H01M 50/446; H01M 50/449

(52) U.S. Cl. CPC H01M 10/056; H01M 4/525; H01M 10/052; H01M 10/4235; H01M 50/426; H01M 50/431; H01M 50/446; H01M 50/449; H01M 2300/008; H01M 2300/0082; H01M 2300/0094

(57) ABSTRACT

A secondary battery including solid electrolyte layers that improves a charge capacity during fast charge is provided. The secondary battery includes a positive electrode, a negative electrode, and a first solid electrolyte layer and a second solid electrolyte layer, each of which contains a solid electrolyte and a binder. The positive electrode and the negative electrode sandwich the first solid electrolyte layer and the second solid electrolyte layer. The first solid electrolyte layer is arranged on the positive electrode and the second solid electrolyte layer is arranged on the negative electrode. A thickness of the first solid electrolyte layer is less than a thickness of the second solid electrolyte layer.

### TECHNICAL FIELD

The present invention relates to a secondary battery using a solid electrolyte.

### BACKGROUND ART

Recently, there has been a strong demand for a reduction in carbon dioxide emissions in order to cope with global warming. The automobile industry expects that the introduction of electric vehicles (EV) or hybrid electric vehicles (HEV) will lead to a reduction in carbon dioxide emissions. Thus, intensive efforts are being made to develop a non-aqueous electrolyte secondary battery such as a secondary battery for driving motors which holds the key to the practical application of those electric vehicles.

The secondary battery for driving motors is required to have extremely high output characteristics and high energy density as compared with a consumer secondary battery used for a mobile phone, a notebook computer, or the like. Therefore, among all practical batteries, a lithium secondary battery having the highest theoretical energy has attracted much attention, and is currently under rapid development.

Here, the lithium secondary battery that is currently in widespread use uses a combustible organic electrolyte solution as an electrolyte. Such liquid lithium secondary battery requires more stringent safety measures than other batteries against liquid leakage, short circuit, overcharge, and the like.

Therefore, in recent years, intensive efforts are being made to research and develop an all-solid-state lithium secondary battery using an oxide-based or sulfide-based solid electrolyte as the electrolyte. The solid electrolyte is a material mainly including an ion conductor capable of ion conduction in a solid. Therefore, in the all-solid-state lithium secondary battery, various problems caused by the combustible organic electrolyte solution as in a conventional liquid lithium secondary battery do not occur in principle. In general, use of a high-potential, high-capacity positive electrode material and a high-capacity negative electrode material significantly improves an output density and an energy density of a battery.

Incidentally, in recent years, there has been an increasing need for the all-solid state secondary battery to have a higher energy density, and accordingly, thinning of a solid electrolyte layer is also required. However, there is a problem that the thinning of the solid electrolyte layer in the all-solid-state lithium secondary battery causes the short circuit. A technique disclosed in WO 2020/166165 A solves such problem by disposing a first solid electrolyte layer and a second solid electrolyte layer in an all-solid state secondary battery. This all-solid state secondary battery is characterized in that a thickness of the first solid electrolyte layer and content of an organic compound are smaller than those of the second solid electrolyte layer.

### SUMMARY OF INVENTION

### Technical Problem

However, according to study of the present inventors, it has been found that the technique described in WO 2020/166165 A may not achieve a sufficient charge capacity when the secondary battery including the solid electrolyte layers is under fast charge.

Therefore, an object of the present invention is to provide a method capable of improving a charge capacity of a secondary battery including solid electrolyte layers during fast charge.

### Solution to Problem

The present inventors have carried out a diligent study in order to solve the problems described above. As a result, the present inventors have found that the above problems can be solved by disposing, in a secondary battery using a solid electrolyte, two solid electrolyte layers, making a thickness of a first solid electrolyte layer located on a positive electrode side smaller than a thickness of a second solid electrolyte layer located on a negative electrode side, and further making a concentration of a binder contained in the first solid electrolyte layer higher than a concentration of a binder in the second solid electrolyte layer within a specific range, thereby completing the present invention.

In other words, one embodiment of the present invention relates to a secondary battery including: a positive electrode in which a positive electrode active material layer is arranged on a surface of a positive electrode current collector; a negative electrode in which a negative electrode active material layer is arranged on a surface of a negative electrode current collector; and a first solid electrolyte layer and a second solid electrolyte layer, each of which contains a solid electrolyte and a binder. Further, the positive electrode and the negative electrode are arranged to face each other in a manner that the positive electrode active material layer and the negative electrode active material layer sandwich the first solid electrolyte layer and the second solid electrolyte layer, the first solid electrolyte layer is arranged on the positive electrode active material layer side, the second solid electrolyte layer is arranged on the negative electrode active material layer side, a thickness of the first solid electrolyte layer is smaller than a thickness of the second solid electrolyte layer, and a ratio (A/B) of a concentration (A) [mass %] of the binder with respect to a total solid content of the first solid electrolyte layer, to a concentration (B) [mass %] of the binder with respect to a total solid content of the second solid electrolyte layer is 1<A/B≤4.5.

### BRIEF DESCRIPTION OF DRAWINGS

FIG. 1 is a perspective view illustrating an appearance of a flat laminate type secondary battery according to one embodiment of the present invention.

FIG. 2 is a cross-sectional view taken along line 2-2 illustrated in FIG. 1.

FIG. 3 is a schematic view illustrating an enlarged cross section of a single battery layer constituting a power generating element of the laminate type secondary battery illustrated in FIGS. 1 and 2.

### DESCRIPTION OF EMBODIMENTS

One embodiment of the present invention is a secondary battery including: a positive electrode in which a positive electrode active material layer is arranged on a surface of a positive electrode current collector; a negative electrode in which a negative electrode active material layer is arranged on a surface of a negative electrode current collector; and a first solid electrolyte layer and a second solid electrolyte layer, each of which contains a solid electrolyte and a binder, in which the positive electrode and the negative electrode are arranged to face each other in a manner that the positive electrode active material layer and the negative electrode active material layer sandwich the first solid electrolyte layer and the second solid electrolyte layer, the first solid electrolyte layer is arranged on the positive electrode active material layer side, the second solid electrolyte layer is arranged on the negative electrode active material layer side, a thickness of the first solid electrolyte layer is smaller than a thickness of the second solid electrolyte layer, and a ratio (A/B) of a concentration (A) [mass %] of a binder with respect to a total solid content of the first solid electrolyte layer, to a concentration (B) [mass %] of a binder with respect to a total solid content of the second solid electrolyte layer is 1<A/B≤4.5. According to the present embodiment, it is possible to improve a charge capacity of the secondary battery including the solid electrolyte layers during fast charge.

Hereinafter, the present embodiment will be described with reference to the drawings, but the technical scope of the present invention should be defined on a basis of the description of the claims, and is not limited only to the following embodiments. Note that dimensional ratios in the drawings are exaggerated for convenience of description, and may be different from the actual ratios. Hereinafter, the present invention will be described using, as an example, a laminate type (internally parallel connection type) all-solid-state lithium secondary battery which is one embodiment of the secondary battery. The all-solid-state lithium secondary battery has an advantage that problems caused by a combustible organic electrolyte solution as in the conventional liquid lithium secondary battery do not occur in principle, and further has an advantage that use of a high-potential, high-capacity positive electrode material and a high-capacity negative electrode material significantly improves an output density and an energy density of a battery.

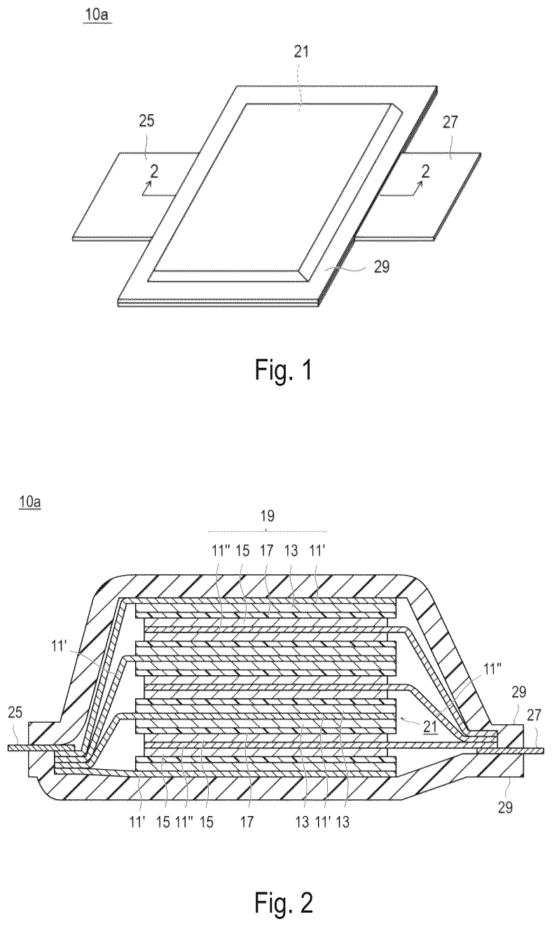

FIG. 1 is a perspective view illustrating an appearance of a flat laminate type all-solid-state lithium secondary battery according to one embodiment of the present invention. FIG. 2 is a cross-sectional view taken along line 2-2 illustrated in FIG. 1. Adopting the laminate type can make the battery compact and have a high capacity. Note that, in the present description, the flat laminate type all-solid-state lithium secondary battery (hereinafter, also simply referred to as a “laminate type secondary battery”) that is not a bipolar type as illustrated in FIGS. 1 and 2 will be described in detail as an example. However, in a case of being viewed in an electrical connection form (electrode structure) inside the secondary battery according to the present embodiment, the present invention can be applied to both a non-bipolar type (internal parallel connection type) battery and a bipolar type (internal series connection type) battery.

As illustrated in FIG. 1, a laminate type secondary battery 10a has a rectangular flat shape, and from both sides thereof, a negative electrode current collecting plate 25 and a positive electrode current collecting plate 27 for extracting electric power are drawn out. A power generating element 21 is wrapped by a battery outer casing material (laminate film 29) of the laminate type secondary battery 10a, a periphery thereof is thermally fused, and the power generating element 21 is sealed in a state where the negative electrode current collecting plate 25 and the positive electrode current collecting plate 27 are drawn out.

As illustrated in FIG. 2, the laminate type secondary battery 10a of the present embodiment has a structure in which the power generating element 21 in a flat and substantially rectangular shape, in which a charge-discharge reaction actually proceeds, is sealed inside the laminate film 29 that is the battery outer casing material. Here, the power generating element 21 has a configuration in which a positive electrode, solid electrolyte layers 17, and a negative electrode are laminated. The positive electrode has a structure in which positive electrode active material layers 15 containing positive electrode active materials are arranged on both surfaces of each of positive electrode current collectors 11″. The negative electrode has a structure in which negative electrode active material layers 13 containing negative electrode active materials are arranged on both surfaces of each of negative electrode current collectors 11′. As described later, the solid electrolyte layers 17 each include two layers of a first solid electrolyte layer and a second solid electrolyte layer.

A negative electrode current collecting plate 25 is attached to the negative electrode current collectors 11′ and a positive electrode current collecting plate 27 is attached to the positive electrode current collectors 11″, and the negative electrode current collecting plate 25 and the positive electrode current collecting plate 27 are electrically connected to the respective electrodes (the negative electrode and the positive electrode), and have a structure to be guided out of the laminate film 29 in a manner of being sandwiched between end parts of the laminate film 29. The negative electrode current collecting plate 25 may be attached to the negative electrode current collectors 11′ via a negative electrode terminal lead (not illustrated), and the positive electrode current collecting plate 27 may be attached to the positive electrode current collectors 11″ of the respective electrodes via a positive electrode terminal lead (not illustrated) by ultrasonic welding, resistance welding, or the like, as necessary.

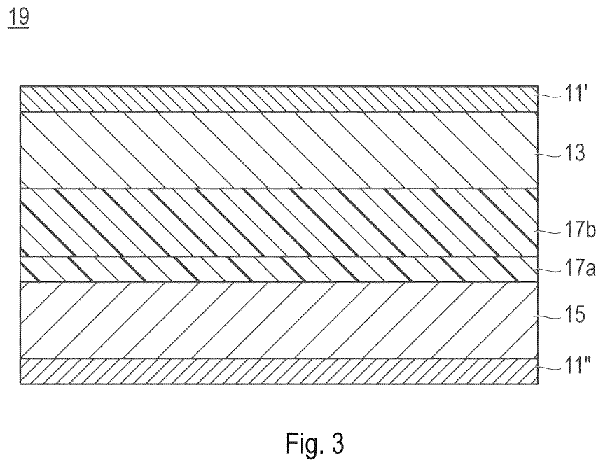

FIG. 3 is a schematic view illustrating an enlarged cross section of a single battery layer 19 constituting the power generating element 21 of the laminate type secondary battery 10a illustrated in FIGS. 1 and 2. As illustrated in FIG. 3, in the present embodiment, the positive electrode active material layer 15 and the negative electrode active material layer 13 are arranged in the single battery layer 19 to sandwich a first solid electrolyte layer 17a and a second solid electrolyte layer 17b, the first solid electrolyte layer 17a is arranged on the positive electrode active material layer 15 side, and the second solid electrolyte layer 17b is arranged on the negative electrode active material layer 13 side. In other words, the single battery layer 19 has a configuration in which the positive electrode current collector 11″, the positive electrode active material layer 15, the first solid electrolyte layer 17a, the second solid electrolyte layer 17b, the negative electrode active material layer 13, and the negative electrode current collector 11′ are laminated in this order. Further, a thickness of the first solid electrolyte layer is smaller than a thickness of the second solid electrolyte layer, and a ratio (A/B) of a concentration (A) [mass %] of the binder with respect to a total solid content of the first solid electrolyte layer, to a concentration (B) [mass %] of the binder with respect to a total solid content of the second solid electrolyte layer is 1<A/B≤4.5.

Since the secondary battery according to the present invention has the above configuration, the charge capacity of the secondary battery including the solid electrolyte layer can be improved during fast charge. Details of the reason why the above effect is achieved are unclear, and the following mechanism is possible.

For example, if the secondary battery such as the lithium secondary battery is charged, the positive electrode active material layer may shrink due to release of lithium from the positive electrode active material. Recently, there has been an increasing need for fast charging the secondary battery, but it has been known that the fast charge of the secondary battery reduces the charge capacity thereof. Here, according to the study of the present inventors, it has been found that a decrease in charge capacity is a phenomenon that occurs because the positive electrode active material layer shrinks rapidly when the secondary battery is in fast charge, and delamination occurs at an interface between the positive electrode active material layer and the solid electrolyte layer.

In the secondary battery according to the present invention, the concentration of the binder contained in the first solid electrolyte layer is higher than the concentration of the binder contained in the second solid electrolyte layer. Therefore, many binders are present on a surface layer of the first solid electrolyte layer. Since these binders bind to the positive electrode active material, the solid electrolyte, a conductive aid, a binder, and the like present on a surface layer of the positive electrode active material layer, it can be considered that adhesion force between the first solid electrolyte layer and the positive electrode active material layer is increased, and delamination of both the layers is suppressed. Further, since the first solid electrolyte layer is thin in thickness, a decrease in ion conductivity is suppressed. Further, since the second solid electrolyte layer disposed together with the first solid electrolyte layer are thick in thickness, it is possible to prevent a short circuit of the secondary battery due to generation of dendrite and cracking of the solid electrolyte layer. Moreover, since the concentration of the binder in the second solid electrolyte layer is low, the ion conductivity can be kept high even if the layer is thick. As described above, in the secondary battery according to the present invention, the adhesion between the positive electrode active material layer and the solid electrolyte layer is enhanced, whereby it is possible to prevent the short circuit due to the generation of the dendrite or the like while preventing the delamination of both the layers, and the ion conductivity of the solid electrolyte layer can be maintained. Therefore, it can be considered that the charge capacity during fast charge can be improved.

In the laminate type secondary battery 10a according to the present embodiment, it is preferable that the power generating element 21 sealed by the laminate film 29 illustrated in FIG. 1 and the power generating element 21 sealed by the laminate film 29 are sandwiched between two plate-like members, and further fastened using a fastening member. Accordingly, the above plate-like member and the above fastening member function as a pressurizing member that pressurizes (restrains) the power generating element 21 in a lamination direction thereof. Examples of the plate-like member include a metal plate, a resin plate, and the like. Further, examples of the fastening member include a bolt, a nut, and the like. However, the pressurizing member is not particularly limited as long as the pressurizing member can pressurize the power generating element 21 in the lamination direction thereof. Typically, a combination of a plate formed by a material having rigidity such as the plate-like member and the above fastening member is used as the pressurizing member. Further, as the fastening member, not only the bolt and the nut but also a tension plate or the like that fixes end parts of the plate-like member to restrain the power generating element 21 in the lamination direction thereof may be used. Note that a lower limit of a load (confining pressure in the lamination direction of the power generating element) applied to the power generating element 21 is, for example, 0.1 MPa or more, preferably 0.5 MPa or more, more preferably 1 MPa or more, and still more preferably 3 MPa or more. An upper limit of the confining pressure in the lamination direction of the power generating element is, for example, 100 MPa or less, preferably 70 MPa or less, more preferably 40 MPa or less, and still more preferably 10 MPa or less.

Hereinafter, main constituent elements of the secondary battery according to the present invention, which has been described above using the laminate type secondary battery 10a as an example, will be described.

### [Current Collector]

The current collectors (the negative electrode current collectors 11′ and the positive electrode current collectors 11″) have a function of mediating transfer of electrons from an electrode active material layer. Materials constituting the current collectors are not particularly limited. As the constituent materials of the current collectors, for example, a metal or a resin having conductivity can be adopted.

Specific examples of the metal include aluminum, nickel, iron, stainless steel, titanium, copper, and the like. In addition, a clad material of the nickel and the aluminum, a clad material of the copper and the aluminum, or the like may be used. Further, a foil in which the metal surface is coated with the aluminum may also be used. Among the metals, the aluminum, the stainless steel, the copper, and the nickel are preferable from a viewpoint of electron conductivity, battery operating potential, adhesion of an active material, or the like.

Further, examples of the latter resin having conductivity include a resin obtained by adding a conductive filler to a conductive polymer material or a non-conductive polymer material as necessary.

Note that the current collectors may have a single-layer structure made of a single material, or may have a laminated structure in which layers made of these materials are appropriately combined. From a viewpoint of weight reduction of the current collectors, it is preferable to include at least a conductive resin layer made of the resin having conductivity.

### [Negative Electrode Active Material Layer]

The negative electrode active material layer contains the negative electrode active material. A type of the negative electrode active material is not particularly limited, and examples thereof includes a carbon material, a metal oxide, and a metal active material. Further, as the negative electrode active material, a metal containing the lithium may also be used. Such negative electrode active material is not particularly limited as long as the negative electrode active material is an active material containing the lithium, and examples thereof include a lithium-containing alloy in addition to metal lithium. Examples of the lithium-containing alloy include an alloy of Li and at least one of In, Al, Si, Sn, Mg, Au, Ag, and Zn. The negative electrode active material preferably contains the metal lithium or the lithium-containing alloy, a silicon-based negative electrode active material, or a tin-based negative electrode active material, and particularly preferably contains the metal lithium or the lithium-containing alloy. Note that, in a case where the metal lithium or the lithium-containing alloy is used as the negative electrode active material, the secondary battery according to the present embodiment may be a so-called lithium deposition type secondary battery in which the metal lithium as the negative electrode active material is caused to be precipitated on the negative electrode current collectors in a charging process. Accordingly, in such embodiment, a thickness of the negative electrode active material layer increases with progress of the charging process, and the thickness of the negative electrode active material layer decreases with progress of a discharging process. The negative electrode active material layer may not be present during complete discharge, but in some cases, the negative electrode active material layer containing a certain amount of the metal lithium may be arranged during the complete discharge.

Content of the negative electrode active material in the negative electrode active material layer is not particularly limited, and for example, is preferably within a range of 40 to 100 mass %, and more preferably within a range of 50 to 90 mass %.

The negative electrode active material layer can further contain the solid electrolyte if necessary. The negative electrode active material layer contains the solid electrolyte, whereby the ion conductivity of the negative electrode active material layer can be improved. Examples of the solid electrolyte include a sulfide solid electrolyte and an oxide solid electrolyte. Note that, in the present description, the solid electrolyte refers to a material mainly including an ion conductor capable of ion conduction in a solid, and particularly refers to a material having a degree of lithium-ion conductivity at normal temperature (25° C.) of 1*10⁻⁵ S/cm or more. The degree of lithium-ion conductivity is preferably 1*10⁻⁴ S/cm or more. Here, a value of the ion conductivity can be measured by an AC impedance method.

From a viewpoint of exhibiting excellent lithium-ion conductivity, the solid electrolyte is preferably a sulfide solid electrolyte containing an S element, more preferably a sulfide solid electrolyte containing a Li element, an M element, and an S element, the M element being at least one element selected from the group consisting of P, Si, Ge, Sn, Ti, Zr, Nb, Al, Sb, Br, Cl, and I, and further preferably a sulfide solid electrolyte containing an S element, a Li element, and a P element.

The sulfide solid electrolyte may have a Li₃PS₄ skeleton, a Li₄P₂S₇ skeleton, or a Li₄P₂S₆ skeleton. Examples of the sulfide solid electrolyte having the Li₃PS₄ skeleton include LiI—Li₃PS₄, LiI—LiBr—Li₃PS₄, and Li₃PS₄. Further, examples of the sulfide solid electrolyte having the Li₄P₂S₇ skeleton include a Li—P—S-based solid electrolyte called LPS. Further, as the sulfide solid electrolyte, for example, LGPS represented by Li₍₄₋ₓ₎Ge₍₁₋ₓ₎PₓS₄ (x satisfies 0<x<1) or the like may also be used. More specifically, examples thereof include LPS (Li₂S—P₂S₅), Li₇P₃S₁₁, Li_{3.2}P_{0.96}S, Li_{3.25}Ge_{0.25}P_{0.75}S₄, Li₁₀GeP₂S₁₂, Li₆PS₅X (here, X is Cl, Br or I), and the like. Note that the description of “Li₂S—P₂S₅” means a sulfide solid electrolyte obtained using a raw material composition containing Li₂S and P₂S₅, and the same applies to other descriptions. In particular, the sulfide solid electrolyte is preferably selected from the group consisting of LPS (Li₂S—P₂S₅), Li₆PS₅X (argyrodite type solid electrolyte, here, X is cl, Br or I), Li₇P₃S₁₁, Li_{3.2}P_{0.96}S, and Li₃PS₄ from a viewpoint of high ion conductivity.

Examples of a shape of the solid electrolyte include a particle shape such as a perfect spherical shape or an elliptical spherical shape, a thin film shape, and the like. In a case where the solid electrolyte is in the particulate shape, an average particle diameter (D50) thereof is not particularly limited, and is preferably 40 μm or less, more preferably 20 μm or less, and still more preferably 10 μm or less. Meanwhile, the average particle diameter (D50) is preferably 0.01 μm or more, and more preferably 0.1 μm or more.

Content of the solid electrolyte in the negative electrode active material layer is, for example, preferably within a range of 1 to 60 mass %, and more preferably within a range of 10 to 50 mass %.

The negative electrode active material layer may further contain at least one of the binder and the conductive aid in addition to the negative electrode active material and the solid electrolyte described above. The thickness of the negative electrode active material layer varies depending on the configuration of the intended secondary battery, and is, for example, preferably within a range of 0.1 to 1000 μm, and more preferably 40 to 100 μm.

### [Solid Electrolyte Layer]

In the secondary battery according to the present embodiment, the solid electrolyte layer includes the first solid electrolyte layer and the second solid electrolyte layer, each of which contains the solid electrolyte and the binder. In the secondary battery according to the present embodiment, the first solid electrolyte layer is arranged on the positive electrode active material layer side, the second solid electrolyte layer is arranged on the negative electrode active material layer side, the thickness of the first solid electrolyte layer is smaller than the thickness of the second solid electrolyte layer, and the ratio (A/B) of the concentration (A) [mass %] of the binder with respect to the total solid content of the first solid electrolyte layer, to the concentration (B) [mass %] of the binder with respect to the total solid content of the second solid electrolyte layer is 1<A/B≤4.5.

The solid electrolyte contained in the first solid electrolyte layer and the second solid electrolyte layer is not particularly limited, and the solid electrolyte exemplified in the section of the negative electrode active material layer and preferred forms thereof can be similarly adopted. In particular, the solid electrolyte contained in the solid electrolyte layer is preferably the sulfide solid electrolyte and more preferably an argyrodite type solid electrolyte (Li₆PS₅X (here, X is Cl, Br or I)) from the viewpoint of high ion conductivity. Further, the solid electrolyte contained in the solid electrolyte layer may be used in combination with a solid electrolyte other than the solid electrolyte exemplified in the section of the negative electrode active material layer. Note that the first solid electrolyte layer and the second solid electrolyte layer may contain solid electrolytes in the same form, or may contain solid electrolytes in different forms. According to a preferred embodiment, the first solid electrolyte layer and the second solid electrolyte layer contain a solid electrolyte in the same form.

Content of the solid electrolyte in each of the first solid electrolyte layer and the second solid electrolyte layer is, for example, preferably within a range of 10 to 100 mass %, more preferably within a range of 50 to 100 mass %, and still more preferably within a range of 90 to 100 mass % with respect to a total mass of the solid electrolyte layer. The content of the solid electrolyte in the first solid electrolyte layer and the second solid electrolyte layer may be the same as or different from each other.

The binder contained in each of the first solid electrolyte layer and the second solid electrolyte layer is not particularly limited, and is a substance stable in a potential range of a charge-discharge operation. From a viewpoint of a strength of the solid electrolyte layer and the adhesion to the positive electrode active material layer, the binder is preferably selected from the group consisting of polyvinylidene fluoride (PVDF), a styrene-butadiene rubber (SBR), an acrylic resin, and polytetrafluoroethylene (PTFE), and more preferably selected from the group consisting of polyvinylidene fluoride (PVDF) and the styrene-butadiene rubber (SBR). Note that the binders contained in the first solid electrolyte layer and the second solid electrolyte layer may be the same as or different from each other.

As described above, the solid electrolytes and the binders contained in the first solid electrolyte layer and the second solid electrolyte layer may be the same as or different from each other. However, in the secondary battery according to one embodiment, the solid electrolyte contained in the first solid electrolyte layer and the solid electrolyte contained in the second solid electrolyte layer are preferably the same as each other, and the binder contained in the first solid electrolyte layer and the binder contained in the second solid electrolyte layer are preferably the same as each other. This makes it possible to more effectively improve the charge capacity of the secondary battery during fast charge.

The concentration (A) of the binder contained in the first solid electrolyte layer is preferably more than 3 mass % and less than 15 mass %, more preferably 4 mass % or more and 10 mass % or less, and still more preferably 5 mass % or more and 8 mass % or less with respect to a total mass of the first solid electrolyte layer. The concentration (A) of the binder in the first solid electrolyte layer is within the above range, whereby it is possible to sufficiently maintain the ion conductivity of the solid electrolyte layer while sufficiently improving the adhesion force to the positive electrode active material layer. Further, the concentration (B) of the binder contained in the second solid electrolyte layer is preferably 1 mass % or more and 10 mass % or less, more preferably 2 mass& or more and 6 mass % or less, and still more preferably 2.5 mass % or more and 4 mass % or less with respect to a total mass of the second solid electrolyte layer. The concentration (B) of the binder in the second solid electrolyte layer is in the above range, whereby it is also possible to sufficiently maintain the ion conductivity while sufficiently maintaining the strength of the solid electrolyte layer.

The ratio ((A)/(B)) of the above concentration (A) of the binder contained in the first solid electrolyte layer, to the above concentration (B) of the binder contained in the second solid electrolyte layer is 1<A/B≥4.5, preferably 1.2 S A/B S 4.0, more preferably 1.5≤A/B≤3.5, and still more preferably 1.8≤A/B≤3.0. The ratio of the concentrations of the binders is in the above range, whereby the charge capacity in a case of fast charge can be more sufficiently improved.

A thickness (a) of the first solid electrolyte layer is not particularly limited as long as the thickness (a) is smaller than the thickness of the second solid electrolyte layer and does not impair performance of an intended secondary battery. For example, the thickness (a) of the first solid electrolyte layer is preferably 0.1 μm or more and 5 μm or less, more preferably 0.5 μm or more and 3 μm or less, and still more preferably 1 μm or more and 2 μm or less. Meanwhile, a thickness (b) of the second solid electrolyte layer is also not particularly limited as long as the thickness (b) is larger than the thickness of the first solid electrolyte layer and does not impair performance of an intended secondary battery. For example, the thickness (b) of the second solid electrolyte layer is preferably 3 μm or more and 50 μm or less, and more preferably 5 μm or more and 30 μm or less. The thickness of the first solid electrolyte layer and the thickness of the second solid electrolyte layer are in the above ranges, whereby it is possible to prevent the short circuit of the secondary battery and to improve the charge capacity in the case of fast charge while keeping an energy density of the secondary battery high.

A proportion (b/a) of the thickness (b) of the second solid electrolyte layer to the thickness (a) of the above first solid electrolyte layer is preferably 1<b/a≤50, more preferably 5≤b/a≤40, and still more preferably 15≤b/a≤35. The proportion of the thicknesses is in the above range, whereby the charge capacity of the secondary battery during fast charge can be more sufficiently improved.

### [Positive Electrode Active Material Layer]

In the secondary battery according to the present embodiment, the positive electrode active material layer is a layer containing the positive electrode active material.

A type of the positive electrode active material is not particularly limited, and examples thereof include layered rock salt type active materials such as LicoO₂, LiMnO₂, LiNiO₂, LiVO₂, and Li(Ni—Mn—Co)O₂, spinel type active materials such as LiMn₂O₄ and LiNi_{0.5}Mn_{1.5}O₄, olivine type active materials such as LiFePO₄ and LiMnPO₄, and Si-containing active materials such as Li₂FeSiO₄ and Li₂MnSiO₄, and the like. Further, examples of an oxide active material other than those described above include Li₄Ti₅O₁₂.

The positive electrode active material layer preferably contains a positive electrode active material that shrinks during charging, and in particular, the positive electrode active material preferably includes a composite oxide containing a lithium element and a nickel element, whereby effects of the present invention can be further exhibited. In general, if the shrinkage of the positive electrode active material occurs, the solid electrolyte layer is delaminated from the positive electrode active material layer. However, the secondary battery according to the present invention can prevent the delamination since the first solid electrolyte layer firmly adheres to the positive electrode active material layer. The positive electrode active material including the composite oxide containing the lithium element and the nickel element is characterized in that the shrinkage during charging is particularly large. However, even in a case of using such positive electrode active material, the secondary battery according to the present invention can suppress the delamination between the positive electrode active material layer and the solid electrolyte layer.

More preferably, Li(Ni—Mn—Co) 02 and a material obtained by substituting some of these transition metals with other elements (hereinafter, also simply referred to as “NMC composite oxide”) are used as the positive electrode active material. The NMC composite oxide has a layered crystal structure in which a lithium atomic layer and a transition metal (in which Mn, Ni, and Co are orderly arranged) atomic layer are alternately laminated with an oxygen atomic layer interposed therebetween, one Li atom is contained per atom of the transition metal M, an amount of Li that can be taken out, that is, a supply capacity is twice that of the spinel type lithium manganese oxide, and the NMC composite oxide can have a high capacity. As described above, the NMC composite oxide also includes a composite oxide in which some of transition metal elements are substituted with other metal elements. Examples of other elements in this case include Ti, Zr, Nb, W, P, Al, Mg, V, Ca, Sr, Cr, Fe, B, Ga, In, Si, Mo, Y, Sn, V, Cu, Ag, Zn, and the like, and Ti, Zr, Nb, W, P, Al, Mg, V, Ca, Sr, and Cr are preferable.

More preferably, an NMC composite oxide having a composition represented by a general formula (1): LiₐNi_{b}Mn_{c}Co_{d}MₓO₂ (in the formula, a, b, c, d, and x satisfy 0.98≤a≤1.2, 0.6≤b≤0.9, 0≤c≤0.4, 0<d≤0.4, 0≤x≤0.3, and b+c+d+x=1, and M is at least one element selected from Ti, Zr, Nb, W, P, Al, Mg, V, Ca, Sr, and Cr) is used as the positive electrode active material. Here, a represents an atomic ratio of Li, b represents an atomic ratio of Ni, c represents an atomic ratio of Mn, d represents an atomic ratio of Co, and x represents an atomic ratio of M. Note that, from a viewpoint of high theoretical discharge capacity, it is preferable that b satisfies 0.6≤b≤0.9 as described above, and from a viewpoint of improving the adhesion between the positive electrode active material layer and the solid electrolyte layer and suppressing an increase in interface resistance therebetween, it is more preferable that b satisfies 0.6≤b≤0.8. Such NMC composite oxide in which content of the nickel element is large has a high capacity, and has a large expansion and shrinkage along with the charge-discharge reaction, so that the problem that the interface resistance is likely to increase as described above can be especially remarkable. Accordingly, by using the NMC composite oxide in which the content of the nickel element is large as the positive electrode active material, the effects of the present invention can be further exhibited.

Further, using the sulfur-based positive electrode active material is also one of preferred embodiments. Examples of the sulfur-based positive electrode active material include particles or thin films of an organic sulfur compound or an inorganic sulfur compound, and any material may be used that can release lithium ions during charge and occlude the lithium ions during discharge utilizing a sulfur oxidation-reduction reaction.

In some cases, two or more types of positive electrode active materials may be used in combination. Note that it is needless to say that a positive electrode active material other than the above may also be used.

Examples of a shape of the positive electrode active material include a particle shape (spherical shape or fibrous shape), a thin film shape, and the like. In a case where the positive electrode active material is in the particulate shape, an average particle diameter (D₅₀) thereof is, for example, preferably within a range of 1 nm to 100 μm, more preferably within a range of 10 nm to 50 μm, still more preferably within a range of 100 nm to 20 μm, and particularly preferably within a range of 1 to 20 μm. Note that, in the present description, a value of the average particle diameter (D₅₀) can be measured by a laser diffraction scattering method.

Content of the positive electrode active material in the positive electrode active material layer is not particularly limited, and is preferably more than 50 mass %, more preferably within a range of more than 50 mass % and 95 mass % or less, and still more preferably within a range of 60 mass % or more and 90 mass % or less, with respect to 100 mass % of a total solid content contained in the positive electrode active material layer.

In the secondary battery according to the present embodiment, the positive electrode active material layer can contain the solid electrolyte in addition to the positive electrode active material. A type of the solid electrolyte contained in the positive electrode active material layer is not particularly limited, and the solid electrolyte more preferably includes the sulfide solid electrolyte. As a specific form and a preferred form of the solid electrolyte such as the sulfide solid electrolyte, those described in the section of the negative electrode (negative electrode active material layer) described above can be similarly adopted.

Content of the solid electrolyte in the positive electrode active material layer is preferably 1 mass % or more and 70 mass % or less, more preferably 5 mass % or more and 50 mass % or less, and still more preferably 10 mass % or more and 30 mass % or less, with respect to 100 mass % of the total solid content contained in the positive electrode active material layer. As long as the content of the solid electrolyte in the positive electrode active material layer is within the above range, both the ion conductivity and the energy density of the positive electrode active material layer can be achieved.

The positive electrode active material layer may further contain at least one of the binder and the conductive aid in addition to the positive electrode active material and the solid electrolyte described above. The thickness of the positive electrode active material layer varies depending on configuration of the intended secondary battery, varies depending on configuration of an intended lithium secondary battery, and is, for example, preferably within a range of 0.1 to 1000 μm, and more preferably 40 to 100 μm.

### [Intermediate Layer]

The secondary battery according to one embodiment of the present invention may have an intermediate layer containing a carbon material between the negative electrode active material layer and the second solid electrolyte layer. Having the intermediate layer can suppress the short circuit due to the generation of the dendrite or the like in the secondary battery, and more sufficiently improve the charge capacity during fast charge.

The carbon material is not particularly limited, and examples thereof include carbon black (specifically, acetylene black, Ketjen black (registered trademark), furnace black, channel black, thermal lamp black, or the like), carbon nanotube (CNT), graphite, hard carbon, and the like. Among the carbon materials, the carbon black is preferable, and at least one selected from the group consisting of the acetylene black, the Ketjen black (registered trademark), the furnace black, the channel black, and thermal lamp black is more preferable.

Content of the carbon material in the intermediate layer is not particularly limited, and is preferably within a range of 50 to 100 mass %, more preferably within a range of 60 to 100 mass %, and still more preferably within a range of 70 to 100 mass %.

Further, in addition to the carbon material, the intermediate layer may also contain, for example, nanoparticles containing one type or two or more types of elements selected from the group consisting of gold, platinum, palladium, silicon, silver, aluminum, bismuth, tin, and zinc.

A thickness of the intermediate layer is not particularly limited, and is preferably within a range of 1 to 50 μm, more preferably within a range of 5 to 40 μm, still more preferably within a range of 10 to 30 μm, and most preferably within a range of 5 to 15 μm. If the thickness of the intermediate layer is 1 μm or more, the short circuit due to the generation of the dendrite can be further suppressed. If a thickness of a carbon-containing layer is 50 μm or less, a decrease in energy density can be suppressed.

### [Positive Electrode Current Collecting Plate and Negative Electrode Current Collecting Plate]

A material constituting the current collecting plates is not particularly limited, and a known highly conductive material conventionally used as a current collecting plate for a secondary battery can be used. As the constituent materials of the current collecting plates, for example, a metal material such as aluminum, copper, titanium, nickel, steel use stainless (SUS), or an alloy thereof is preferable. From a viewpoint of lightweight, corrosion resistance, and high conductivity, the aluminum and the copper are more preferable, and the aluminum is particularly preferable. Note that the same material or different materials may be used for the positive electrode current collecting plate 27 and the negative electrode current collecting plate 25.

### [Positive Electrode Lead and Negative Electrode Lead]

Further, although not illustrated, the current collectors may be electrically connected to the current collecting plates via the positive electrode lead or the negative electrode lead. As constituent materials of the positive electrode lead and the negative electrode lead, materials used in a known lithium secondary battery can be similarly adopted. Note that a portion taken out from the casing is preferably covered with a heat-resistant, insulating, heat-shrinkable tube or the like without affecting a product (for example, an automotive component, in particular electronic device or the like) due to electric leakage by contact with peripheral equipment, wiring, or the like.

### [Battery Outer Casing Material]

As the battery outer casing material, a known metal can case can be used, and a bag-shaped case using the laminate film 29 containing the aluminum, which can cover the power generating element as illustrated in FIGS. 1 and 2, can be used. As the laminate film, for example, a laminate film having a three-layer structure or the like formed by laminating PP, aluminum, and nylon in this order can be used, and the laminate film is not limited thereto. The laminate film is desirable from a viewpoint of high output, excellent cooling performance, and suitability for used in batteries for large-size equipment such as EV and HEV. Further, since a group pressure applied to the power generating element from the outside can be easily adjusted, the laminate film containing the aluminum is more preferable as a casing body.

The secondary battery according to the present embodiment has a configuration in which a plurality of single battery layers are connected in parallel, and thus has a high capacity and excellent cycle durability. Accordingly, the secondary battery according to the present embodiment is suitably used as a power source for driving EV and HEV.

Although one embodiment of the secondary battery of the present invention has been described above, the present invention is not limited to only the configuration described in the embodiments described above, and may be appropriately changed on a basis of descriptions of claims. For example, in the above description, the all-solid-state type secondary battery in which all the electrolytes contained in the solid electrolyte layer are solid has been described as an example. However, the lithium secondary battery according to the present embodiment may not be the all-solid-state type. In other words, the solid electrolyte layer may further contain a conventionally known liquid electrolyte (electrolyte solution). An amount of the liquid electrolyte (electrolyte solution) that can be contained in the solid electrolyte layer is not particularly limited, and is preferably such an amount that the shape of the solid electrolyte layer formed by the solid electrolyte is maintained and liquid leakage of the liquid electrolyte (electrolyte solution) does not occur. Note that, as the liquid electrolyte (electrolyte solution), there is used a solution having a form in which a conventionally known lithium salt is dissolved in a conventionally known organic solvent. The liquid electrolyte (electrolyte solution) may further contain an additive other than the organic solvent and the lithium salt. These additives may be used singly or two or more types thereof may be used in combination. Further, an amount of the additive used in the electrolyte solution can be appropriately adjusted.

Note that the following embodiments are also included in the scope of the present invention: the secondary battery according to claim 1, having the features of claim 2; the secondary battery according to claim 1 or 2, having the features of claim 3; the secondary battery according to any one of claims 1 to 3, having the features of claim 4; the secondary battery according to any one of claims 1 to 4, having the features of claim 5; the secondary battery according to any one of claims 1 to 5, having the features of claim 6; the secondary battery according to any one of claims 1 to 6, having the features of claim 7; the secondary battery according to any one of claims 1 to 7, having the features of claim 8; the secondary battery according to claim 4, having the features of claim 9; the secondary battery according to any one of claims 1 to 9, having the features of claim 10; the secondary battery according to any one of claims 1 to 10, having the features of claim 11; and the secondary battery according to any one of claims 1 to 11, having the features of claim 12.

### EXAMPLES

Hereinafter, the present invention will be described in more detail with reference to examples. However, the technical scope of the present invention is not limited only to the following examples. Note that, in the following description, instruments, devices, and the like used in a glove box were sufficiently dried in advance.

### <Preparation Example of Evaluation Cell>

### Example 1

### (Preparation of Positive Electrode Active Material Layer)

As a constituent material of the positive electrode active material layer, the NMC composite oxide (LiNi_{0.8}Mn_{0.1}Co_{0.1}O₂ (NMC811)) as the positive electrode active material, an argyrodite-type sulfide solid electrolyte (Li₆PS₅Cl) as the solid electrolyte, the acetylene black as the conductive aid, and the polytetrafluoroethylene (PTFE) as the binder were prepared. In a glove box under an argon atmosphere at a dew point of −68° C. or lower, the positive electrode active material, the solid electrolyte, the conductive aid, and the binder were weighed to have a mass ratio of 79:16: 3:2, and kneaded in an agate mortar to obtain a powder composition (positive electrode mixture).

Next, the powder composition (positive electrode mixture) obtained above was molded into a sheet shape having a thickness of 100 μm using a hand roller. The sheet was punched into a square having a size of 19 mm on one side to prepare the positive electrode active material layer.

### (Preparation of First Solid Electrolyte Layer)

In the glove box under the argon atmosphere at the dew point of −68° C. or lower, 94 parts by mass of the argyrodite-type sulfide solid electrolyte (Li₆PS₅Cl) as the solid electrolyte and a binder solution (obtained by dissolving 6 parts by mass of the styrene-butadiene rubber (SBR) as the binder in mesitylene as a solvent) were mixed to prepare a solid electrolyte slurry. The obtained solid electrolyte slurry was applied on a surface of a stainless steel foil as a support using an applicator, dried, and then punched into a square having a size substantially equal to or one size larger than that of the positive electrode active material layer to obtain a first solid electrolyte layer having a thickness of 1 μm and a binder concentration of 6 mass %.

### (Preparation of Second Solid Electrolyte Layer)

In the glove box under the argon atmosphere at the dew point of −68° C. or lower, 95 parts by mass of the argyrodite-type sulfide solid electrolyte (Li₆PS₅Cl) as the solid electrolyte and a binder solution (obtained by dissolving 5 parts by mass of the styrene-butadiene rubber (SBR) as the binder in mesitylene as a solvent) were mixed to prepare a solid electrolyte slurry. The obtained solid electrolyte slurry was applied on a surface of a stainless steel foil as the support using the applicator, dried, and then punched into a square having a size substantially equal to or one size larger than that of the positive electrode active material layer to obtain a second solid electrolyte layer having a thickness of 30 μm and a binder concentration of 5 mass %.

### (Preparation of Intermediate Layer)

Silver nanoparticles and carbon black were mixed at a mass ratio of 1:3 to obtain a mixture. Next, a binder solution (obtained by dissolving the styrene-butadiene rubber (SBR) as the binder in the mesitylene as the solvent) was added and mixed such that the mixture was 5 mass& with respect to the total solid content to obtain a slurry. Next, the slurry was applied on a surface of a stainless steel foil as the support using the applicator, dried, and then punched into a square having a size substantially equal to or one size larger than that of the positive electrode active material layer to obtain an intermediate layer having a thickness of 10 μm.

### (Production of Evaluation Cell)

The positive electrode active material layer was overlaid on an aluminum foil (in a square shape almost equal to or one size larger than the positive electrode active material layer) as the positive electrode current collector. Then, the first solid electrolyte layer formed on a surface of the stainless steel foil was overlaid on the positive electrode active material layer such that an exposed surface of the solid electrolyte layer faced the positive electrode active material layer, and the solid electrolyte layer was transferred onto the positive electrode active material layer by cold isostatic pressing (CIP). After the stainless foil adjacent to the first solid electrolyte layer was delaminated, the second solid electrolyte layer formed on the surface of the stainless steel foil was overlaid on the transferred first solid electrolyte layer such that an exposed surface of the second solid electrolyte layer faced the first solid electrolyte layer, and the second solid electrolyte layer was transferred onto the first solid electrolyte layer by the cold isostatic pressing (CIP). Next, after the stainless foil adjacent to the second solid electrolyte layer was delaminated, the intermediate layer was overlaid on the transferred second solid electrolyte layer, the stainless steel foil as the negative electrode current collector was further overlaid on the intermediate layer, laminated with the laminate film, and pressed by the cold isostatic pressing (CIP) to obtain an evaluation cell.

### Example 2

An evaluation cell of Example 2 was obtained in a similar manner as in Example 1 except that the concentration of the binder in the first solid electrolyte layer was 5.1 mass % and the concentration of the binder in the second solid electrolyte layer was 3 mass %.

### Example 3

An evaluation cell of Example 3 was obtained in a similar manner as in Example 1 except that the concentration of the binder in the first solid electrolyte layer was 6 mass % and the concentration of the binder in the second solid electrolyte layer was 3 mass %.

### Example 4

An evaluation cell of Example 4 was obtained in a similar manner as in Example 1 except that the concentration of the binder in the first solid electrolyte layer was 9.9 mass& and the concentration of the binder in the second solid electrolyte layer was 3 mass %.

### Example 5

An evaluation cell of Example 5 was obtained in a similar manner as in Example 1 except that the concentration of the binder in the first solid electrolyte layer was 12 mass % and the concentration of the binder in the second solid electrolyte layer was 3 mass %.

### Example 6

An evaluation cell of Example 6 was obtained in a similar manner as in Example 1 except that the concentration of the binder in the first solid electrolyte layer was 9.9 mass %, the concentration of the binder in the second solid electrolyte layer was 3 mass %, further the thickness of the first solid electrolyte layer was 5 μm, and the thickness of the second solid electrolyte layer was 25 μm.

### Comparative Example 1

An evaluation cell of Comparative Example 1 was obtained in a similar manner as in Example 1 except that the concentration of the binder in the first solid electrolyte layer was 3 mass % and the concentration of the binder in the second solid electrolyte layer was 3 mass %.

### Comparative Example 2

An evaluation cell of Comparative Example 2 was obtained in a similar manner as in Example 1 except that the concentration of the binder in the first solid electrolyte layer was 15 mass % and the concentration of the binder in the second solid electrolyte layer was 3 mass %.

### Comparative Example 3

An evaluation cell of Comparative Example 3 was obtained in a similar manner as in Example 1 except that the concentration of the binder in the first solid electrolyte layer was 9.9 mass %, the concentration of the binder in the second solid electrolyte layer was 3 mass %, further the thickness of the first solid electrolyte layer was 15 μm, and the thickness of the second solid electrolyte layer was 15 μm.

### Comparative Example 4

An evaluation cell of Comparative Example 4 was obtained in a similar manner as in Example 1 except that the concentration of the binder in the first solid electrolyte layer was 9.9 mass %, the concentration of the binder in the second solid electrolyte layer was 3 mass %, further the thickness of the first solid electrolyte layer was 25 μm, and the thickness of the second solid electrolyte layer was 5 μm.

### Comparative Example 5

An evaluation cell of Comparative Example 5 was obtained in a similar manner as in Example 1 except that the concentration of the binder in the first solid electrolyte layer was 9.9 mass %, the concentration of the binder in the second solid electrolyte layer was 3 mass %, further the thickness of the first solid electrolyte layer was 30 μm, and the thickness of the second solid electrolyte layer was 1 μm.

### Examples 7 to 11 and Comparative Examples 6 to 7

Each of evaluation cells of Examples 7 to 11 and Comparative Examples 6 to 7 was obtained by a similar method as in Examples 1 to 5 and Comparative Examples 1 to 2 except that the polyvinylidene fluoride (PVDF) was used as the binders contained in the first solid electrolyte and the second solid electrolyte layer.

### <Observation of Adhesion Surface Between First Solid Electrolyte Layer and Positive Electrode Active Material Layer>

Each of the evaluation cells prepared above was cut along the lamination direction, and cross sections of the first solid electrolyte layer and the positive electrode active material layer were observed using an EPMA (electron probe microanalyzer). As a result of the observation, on the adhesion surface between the first solid electrolyte layer and the positive electrode active material layer, it was confirmed that the binder (SBR or PVDF) present on the surface layer of the first solid electrolyte layer was bound to the positive electrode active material (NMC811), the solid electrolyte (Li₆PS₅Cl), the conductive aid (acetylene black), and the binder (SBR) which are present on the surface layer of the positive electrode active material layer.

### <Evaluation of Fast Charge Characteristics>

For each of the evaluation cells prepared in respective the above examples and comparative examples, the positive electrode lead was connected to the positive electrode current collector and the negative electrode lead was connected to the negative electrode current collector, and the charge capacity was evaluated according to the following procedure. For measurement, a charge-discharge test apparatus (HJ-SD8 manufactured by HOKUTO DENKO CORPORATION) was used. Further, the measurement was performed in a constant temperature thermostatic bath set at 60° C., and further, was performed while applying a confining pressure of 3 MPa in the lamination direction of the evaluation cells using the pressurizing member.

First, for each of the evaluation cells of Examples 1 to 11 and Comparative Examples 1 to 7, constant current (CC) discharge was performed at a current value equivalent to 0.1 C and a lower limit voltage of 0.5 V. Next, the battery was charged from 0.5 V to 2.5 V at a constant current of 0.1 C in a constant current/constant voltage mode, and the charge capacity at this time was measured. Thereafter, the constant current (CC) discharge was performed at a current value equivalent to 2 C and a lower limit voltage of 0.5 V. Next, the battery was charged from 0.5 V to 2.5 V at a constant current of 2 C in the constant current/constant voltage mode, and the charge capacity at this time was measured. Then, a charge capacity ratio ((charge capacity value during the charge at 2 C)/(charge capacity value during the charge at 0.1 C)), which was a value obtained by dividing the charge capacity during the charge at 2 C by the charge capacity during the charge at 0.1 C, was calculated and used as an evaluation index of the fast charge characteristics.

TABLE 1

| | | First solid | | Second solid | | | | |
|---|---|---|---|---|---|---|---|---|
| | | electrolyte layer | | electrolyte layer | | | | |
| | Solid | Film | Binder | Film | Binder | Layer | Binder | |
| | electrolyte | thickness | concentration | thickness | concentration | thickness | concentration | Charge |
| | layer | (a) | (A) | (b) | (B) | proportion | ratio | capacity |
| | binder | [μm] | [wt %] | [μm] | [wt %] | (b/a) | (A/B) | ratio |
| Example 1 | SBR | 1 | 6 | 30 | 5 | 30 | 1.2 | 0.66 |
| Example 2 | SBR | 1 | 5.1 | 30 | 3 | 30 | 1.7 | 0.77 |
| Example 3 | SBR | 1 | 6 | 30 | 3 | 30 | 2 | 0.81 |
| Example 4 | SBR | 1 | 9.9 | 30 | 3 | 30 | 3.3 | 0.75 |
| Example 5 | SBR | 1 | 12 | 30 | 3 | 30 | 4 | 0.57 |
| Example 6 | SBR | 5 | 9.9 | 25 | 3 | 5 | 3.3 | 0.67 |
| Comparative | SBR | 1 | 3 | 30 | 3 | 30 | 1 | 0.44 |
| Example 1 | | | | | | | | |
| Comparative | SBR | 1 | 15 | 30 | 3 | 30 | 5 | 0.34 |
| Example 2 | | | | | | | | |
| Comparative | SBR | 15 | 9.9 | 15 | 3 | 1 | 3.3 | 0.31 |
| Example 3 | | | | | | | | |
| Comparative | SBR | 25 | 9.9 | 5 | 3 | 0.2 | 3.3 | 0.24 |
| Example 4 | | | | | | | | |
| Comparative | SBR | 30 | 9.9 | 1 | 3 | 0.03 | 3.3 | 0.21 |
| Example 5 | | | | | | | | |
| Example 7 | PVDF | 1 | 6 | 30 | 5 | 30 | 1.2 | 0.56 |
| Example 8 | PVDF | 1 | 5.1 | 30 | 3 | 30 | 1.7 | 0.64 |
| Example 9 | PVDF | 1 | 6 | 30 | 3 | 30 | 2 | 0.67 |
| Example 10 | PVDF | 1 | 9.9 | 30 | 3 | 30 | 3.3 | 0.58 |
| Example 11 | PVDF | 1 | 12 | 30 | 3 | 30 | 4 | 0.53 |
| Comparative | PVDF | 1 | 3 | 30 | 3 | 30 | 1 | 0.39 |
| Example 6 | | | | | | | | |
| Comparative | PVDF | 1 | 15 | 30 | 3 | 30 | 5 | 0.25 |
| Example 7 | | | | | | | | |

As shown in Table 1, in the evaluation cells of the examples, the charge capacity ratios were higher than those of the comparative examples. This indicates that in the evaluation cells of the examples, the charge capacities are maintained at a high proportion even in a case of fast charge at 2 C. Accordingly, it was shown that the charge capacity of the secondary battery according to the present invention was improved even in the case of fast charge.

### REFERENCE SIGNS LIST

10a Laminate type secondary battery
11′ Negative electrode current collector
11″ Positive electrode current collector
13 Negative electrode active material layer
15 Positive electrode active material layer
17 Solid electrolyte layer
17a First solid electrolyte layer
17b Second solid electrolyte layer
5 19 Single battery layer
21 Power generating element
25 Negative electrode current collecting plate
27 Positive electrode current collecting plate
29 Laminate film

1. A secondary battery comprising:
a positive electrode;
a negative electrode; and
a first solid electrolyte layer and a second solid electrolyte layer, each of which contains a solid electrolyte and a binder, wherein:
the positive electrode and the negative electrode sandwich the first solid electrolyte layer and the second solid electrolyte layer;
the first solid electrolyte layer is arranged on the positive electrode, the second solid electrolyte layer is arranged on the negative electrode;
a thickness of the first solid electrolyte layer is less than a thickness of the second solid electrolyte layer; and
a ratio (A/B) of a concentration (A) [mass %] of the binder with respect to a total solid content of the first solid electrolyte layer, to a concentration (B) [mass %] of the binder with respect to a total solid content of the second solid electrolyte layer is 1.5≤A/B≤3.5.

2. A secondary battery comprising:
a positive electrode;
a negative electrode; and
a first solid electrolyte layer and a second solid electrolyte layer, each of which contains a solid electrolyte and a binder, wherein;
the positive electrode sandwich the first solid electrolyte layer and the second solid electrolyte layer;
the first solid electrolyte layer is arranged on the positive electrode, the second solid electrolyte layer is arranged on the negative electrode;
a thickness of the first solid electrolyte layer is less than a thickness of the second solid electrolyte layer;
a ratio (A/B) of a concentration (A) [mass %] of the binder with respect to a total solid content of the first solid electrolyte layer, to a concentration (B) [mass %] of the binder with respect to a total solid content of the second solid electrolyte layer is 1<A/B≤4.5; and
the first solid electrolyte layer and the second solid electrolyte layer contain solid electrolytes in the same form.

3. A secondary battery comprising:
a positive electrode;
a negative electrode; and
a first solid electrolyte layer and a second solid electrolyte layer, each of which contains a solid electrolyte and a binder, wherein:
the positive electrode and the negative electrode sandwich the first solid electrolyte layer and the second solid electrolyte layer;
the first solid electrolyte layer is arranged on the positive electrode, the second solid electrolyte layer is arranged on the negative electrode;
a thickness of the first solid electrolyte layer is less than a thickness of the second solid electrolyte layer;
a ratio (A/B) of a concentration (A) [mass %] of the binder with respect to a total solid content of the first solid electrolyte layer, to a concentration (B) [mass %] of the binder with respect to a total solid content of the second solid electrolyte layer is 1<A/B≤4.5; and
the first solid electrolyte layer and the second solid electrolyte layer contain solid electrolytes having the same average particle diameter.

4. (canceled)

5. The secondary battery according to claim 2, wherein the ratio (A/B) is 1.2≤A/B≤4.0.

6. The secondary battery according to claim 1, wherein a thickness of the first solid electrolyte layer is 0.1 μm or more and 5 μm or less.

7. (canceled)

8. The secondary battery according to claim 1, wherein the binders are selected from the group consisting of polyvinylidene fluoride, a styrene-butadiene rubber, an acrylic resin, and polytetrafluoroethylene.

9. The secondary battery according to claim 1, wherein the concentration (A) of the binder with respect to a total solid content of the first solid electrolyte layer is more than 3 mass % and less than 15 mass %.

10. The secondary battery according to claim 1, wherein a proportion (b/a) of a thickness (b) of the second solid electrolyte layer to a thickness (a) of the first solid electrolyte layer is 1<b/a≤50.

11. The secondary battery according to claim 1, wherein:
the solid electrolyte contained in the first solid electrolyte layer and the solid electrolyte contained in the second solid electrolyte layer are the same as each other; and
the binder contained in the first solid electrolyte layer and the binder contained in the second solid electrolyte layer are the same as each other.

12. The secondary battery according to claim 1, wherein the positive electrode comprises a positive electrode active material including a composite oxide containing a lithium element and a nickel element.

13. The secondary battery according to claim 1, further comprising an intermediate layer containing a carbon material between the negative electrode and the second solid electrolyte layer.

14. The secondary battery according to claim 1, wherein the solid electrolyte contained in the first solid electrolyte layer and the solid electrolyte contained in the second solid electrolyte layer are argyrodite type solid electrolytes (Li₆PS₅X (here, X is Cl, Br or I)).

15. The secondary battery according to claim 1, wherein the secondary battery is an all-solid-state lithium secondary battery.

16. The secondary battery according to claim 2, wherein the ratio (A/B) is 1.5≤A/B≤3.5.

17. The secondary battery according to claim 1, wherein the ratio (A/B) is 1.8≤A/B≤3.0.

18. The secondary battery according to claim 2, wherein a thickness of the first solid electrolyte layer is 0.1 μm or more and 5 μm or less.

19. The secondary battery according to claim 2, wherein the binders are selected from the group consisting of polyvinylidene fluoride, a styrene-butadiene rubber, an acrylic resin, and polytetrafluoroethylene.

20. The secondary battery according to claim 2, wherein the concentration (A) of the binder with respect to a total solid content of the first solid electrolyte layer is more than 3 mass % and less than 15 mass %.

21. The secondary battery according to claim 2, wherein a proportion (b/a) of a thickness (b) of the second solid electrolyte layer to a thickness (a) of the first solid electrolyte layer is 1<b/a≤50.

22. The secondary battery according to claim 2, wherein the positive electrode comprises a positive electrode active material including a composite oxide containing a lithium element and a nickel element.
